(19) United States
(12) Patent Application Publication
(10) Pub. No.: US 2007/0002079 A1
(43) Pub. Date: Jan. 4, 2007

(54) Image display device and method of calibrating an image position and/or size on an image display device

(75) Inventor: Randolph W. Nash, McMinnville, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: InFocus Corporation

(21) Appl. No.: 11/172,752

(22) Filed: Jun. 30, 2005

(51) Int. Cl. G09G 5/00

(52) U.S. Cl. 345/648

(57) ABSTRACT

A display device and a method of calibrating at least one of a size and a position of an image on a display screen of the display device are disclosed, wherein the method includes displaying a calibration indicator in an initial location on the display screen, receiving an input requesting a repositioning of the indicator to a changed location on the display screen and, in response, changing the location of the indicator to the changed location on the display screen, and adjusting at least one of the size and the position of the image displayed on the screen from at least one of an initial size and an initial position based upon the changed location of the indicator.

### TECHNICAL FIELD

The present disclosure relates to an image display device, and to methods for calibrating a position and/or size of an image displayed on the image display device.

### SUMMARY

One embodiment provides a method of calibrating at least one of a size and a position of an image on a display screen of a display device, wherein the method includes displaying a location indicator in an initial location on the display screen, receiving an input requesting a repositioning of the location indicator to a changed location on the display screen, changing the location of the location indicator to the changed location on the display screen, and adjusting at least one of the size and the position of the image displayed on the screen from at least one of an initial size and an initial position based upon the changed location of the location indicator.

### BRIEF DESCRIPTION OF THE DRAWINGS

FIG. 1 shows an exemplary embodiment of a rear projection display device.

FIG. 2 shows a block diagram of an exemplary image display device.

FIG. 3 shows a flow diagram of an exemplary embodiment of a method of calibrating an image size and location in an image display device.

FIG. 4 shows a front view of an exemplary embodiment of a display device, with an exemplary location indicator shown on the display device.

FIG. 5 shows the location indicator of FIG. 4 after an adjustment of a left border indicator.

FIG. 6 shows the location indicator of FIG. 4 after adjustment of a top border indicator.

FIG. 7 shows the location indicator of FIG. 4 after adjustment of a right border indicator.

FIG. 8 shows the location indicator of FIG. 4 after adjustment of a bottom border indicator.

### DETAILED DESCRIPTION OF THE DEPICTED EMBODIMENTS

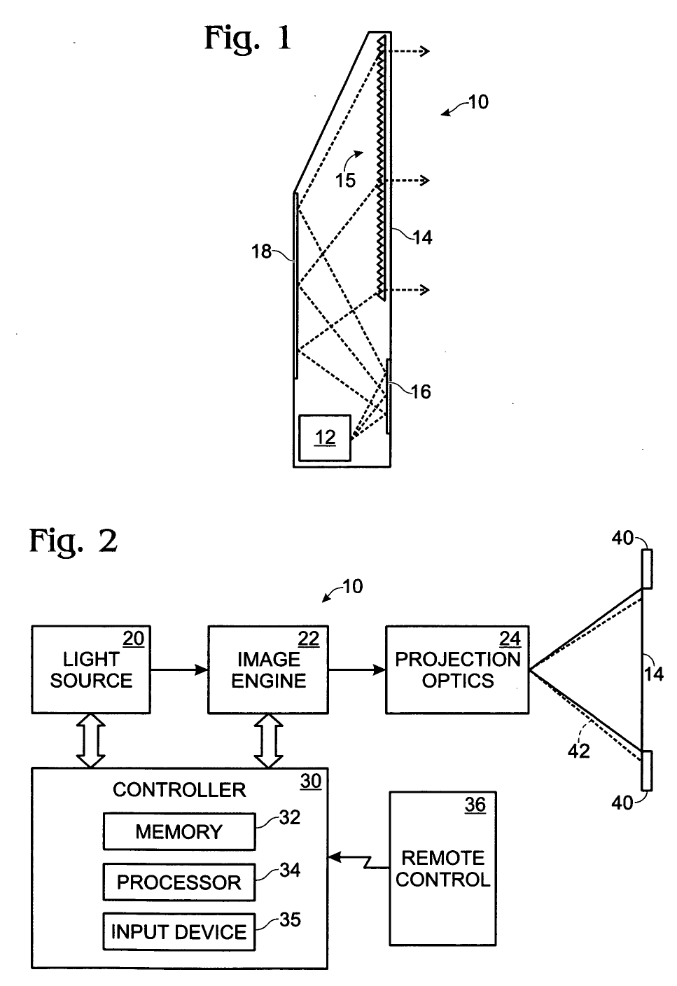

FIG. 1 shows an exemplary embodiment of a display device 10. The depicted display device 10 is a rear projection display device, and includes image-producing components 12, a display screen 14, and reflective surfaces 16 and 18 that increase the length of the optical path between image-producing components 12 and display screen 14, allowing the projection of a larger image on display screen 14. Display screen 14 is shown to have a Fresnel lens-type surface 15 to redirect incident light through screen 14 and toward a viewer, but screen 14 may have any other suitable configuration. The depicted rear projection display device 10 may be a short-throw display device, or a conventional rear projection display device. While shown and described in the context of a rear projection display device, it will be appreciated that the concepts disclosed herein may also be applied to a cathode ray tube (CRT) display device, or any other suitable type of display device.

FIG. 2 shows an exemplary block diagram of components that may make up image display components 10. Image display components 10 may include a light source 20 for producing a beam of light for image generation, an image engine 22 for producing an image via the beam of light, and projection optics 24 for projecting the image on display screen 14. Display device 10 may also include a controller 30 including memory 32, a processor 34 and an optional input device 35, for controlling light source 20, image engine 22, projection optics 24 and/or any other suitable component of display device 10. Display device 10 may also be configured to receive input from a user input device. For example, display device 10 may also be configured to receive input from a user input device, a keypad on the display device or remote from the display device, and/or a remote control device 36.

Light source 20 may include a lamp, one or more LEDs, or any other suitable light-producing element. Light source 20 may also include various components for conditioning and processing the light before image generation, including but not limited to lenses, integrators, color wheels, etc.

Image engine 22 may include any suitable component for producing an image. Examples include, but are not limited to, one or more liquid crystal displays (LCD), one or more liquid crystal on silicon (LCOS) devices, one or more digital micromirror displays (DMD), etc.

Screen 14 may include a bezel 40 that defines an outer border of a viewing area on screen 14. Typically, an image projected is onto screen 14 such that the image has a larger area than the viewing area of screen 14. In this manner, bezel 40 blocks a thin outer region of the image. This may be referred to generally as overscanning. Overscanning helps to hide imperfections and/or roughness that may exist at the edge of the image such that a viewer sees a crisp, straight border defined by the inner perimeter of bezel 40.

The quality of the appearance of an image on display screen 14 may depend on the proper alignment of the system optics, including but not limited to light source 20, image engine 22 and projection optics 24. Where the optics are not properly aligned along the optical axis of the display device, the image may not be centered properly on screen 14. Therefore, one or more edges of the image may not be hidden behind bezel 40, and/or parts of the image intended to be viewed may be hidden behind bezel 40, as indicated at 42 in FIG. 2.

Exact alignment of the optics of display device 10 may be difficult to achieve when assembling display device 10. Therefore, display device 10 may include image calibration capabilities to allow a position and/or a size of an image to be adjusted after device assembly. Conventional image calibration routines typically require a user to adjust the image size and image position in separate steps. Adjusting the image size typically changes the location of the image on the screen. Therefore, the image location typically must be adjusted after adjusting the image size. Likewise, adjusting the location often reveals errors in a prior image size adjustment, requiring the image size to be readjusted. In this manner, the image calibration procedure often becomes an iterative process that may require many separate adjustments to be made to the image size and image location. This can increase production time and costs. Furthermore, in some circumstances, an end user may have to re-adjust the image, for example, due to slight image displacements caused by shocks to the display device 10. This conventional iterative image adjustment process may be difficult to perform for an end user with little to no practice in image adjustment.

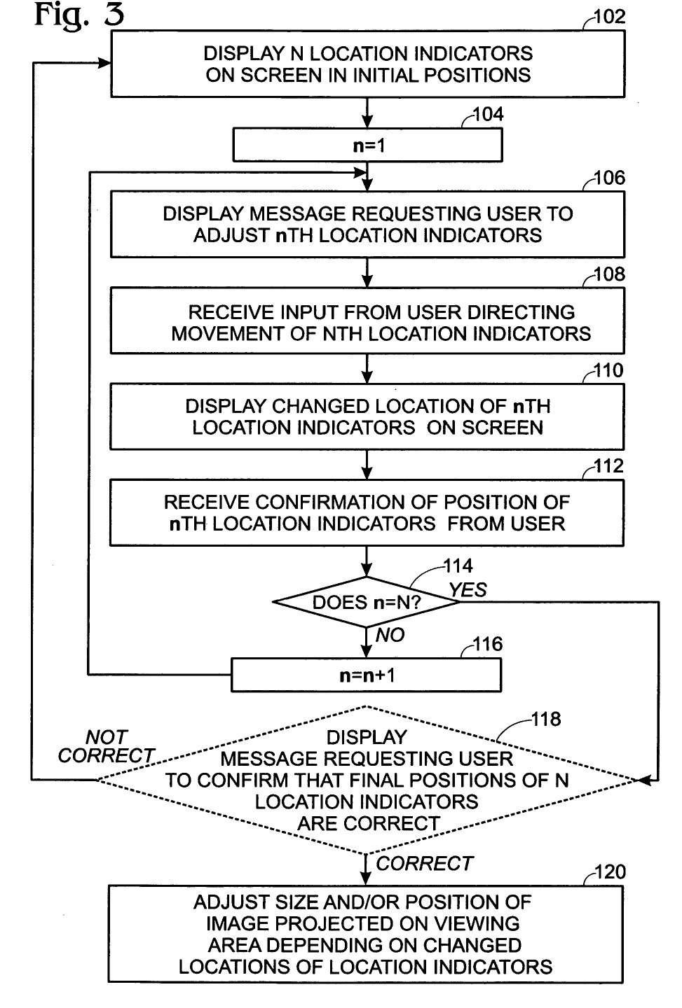

FIG. 3 shows generally an exemplary embodiment of an improved method of adjusting an image/size or location for an image display device. The method of FIG. 3 is generally performed by processor 34 via the execution of code stored in memory 32. The method of FIG. 3 includes, at 102, displaying at least one calibration or location indicator on display screen 14 in an initial position. The location indicator is some sort of indicator, such as a shape, a symbol, a point, or any other suitable visual indicator, that can be moved or manipulated by a user to locate a reference point on screen 14. For example, the location indicator may be used to indicate a location of a border of display screen. Such an indicator may also be referred to as border-locating indicator.

Any suitable number of location indicators may be used. For example, in some embodiments, an indicator is displayed for each side of screen 14. Therefore, in the specific embodiment of a screen with a rectangular shape, N may be equal to four. The number of indicators is thus shown as N in FIG. 3, indicating that one or more indicators may be used.

Any suitable position on screen 14 may be used as the initial position for the location indicator. Suitable positions include, but are not limited to, positions that are visible when the overall image displayed on display screen 14 is incorrectly sized or located.

Next, the method of FIG. 3 includes initializing a counter variable n at 104. The counter variable n is used in the depicted embodiment to generalize the description of the method for any number N of indicators. It therefore will be appreciated that specific implementations of the described method may not utilize a counter variable where a fixed number of indicators is always used for calibration.

The method of FIG. 3 next includes, at 106, displaying on screen 14 a message requesting a user to adjust an nth location indicator to an adjusted or moved location. For example, where the location indicator is a border-locating indicator, the user may be requested to move the indicator to a left, top, right, bottom, or, in a non-rectangular display, to any other suitable border. Alternatively, in some embodiments, such a message may be omitted, for example, when instructions on how to perform the method are contained in a user's manual.

Next, method of FIG. 3 includes, at 108, receiving input from the user directing the movement of the nth location indicator to the appropriate reference point on display screen 14, and then, at 110, displaying the nth location indicator in the changed location. For example, where the location indicator is a border-locating indicator, the input may direct the location indicator to be moved to a position adjacent to or directly against the border of the viewing area of display screen 14. The movement of the indicator may be displayed in real-time, such that the indicator image is moved on the display as the user inputs the instruction to move, or may be shown in any other suitable manner.

Any suitable input device may be used to make the input. For example, the input may be received from the user from an input device, such as a user-operable input device, including an onboard keypad, a remote keypad and/or other remote control device. Examples include, but are not limited to, input device 35 located on display device 10, remote control device 36, a keyboard (not shown), a computer, a handheld computer, a telephone, etc. In specific embodiments, a user may use arrow keys on remote control device 36 or input device 35 to move the indicator across display screen 14. This may provide a quick and intuitive visually-based method of adjusting the position of the location indicator.

Next, method of FIG. 3 includes, at 112, receiving a confirmation from the user that the nth indicator is in a desired position. For example, after placing the location indicator in a desired location relative to a locating feature on display screen 14, a user may push a “select” or “enter” key on a keypad, indicating that the user has completed moving the nth indicator to the desired location. Alternatively, the confirmation may be input in any other suitable manner.

The method of FIG. 3 next includes determining whether there are any more indicators to be set, as shown at 114. If there are more indicator to be set, then the method as illustrated proceeds to setting the next indicator (which is represented in FIG. 3 by increasing the counter variable n by one at 116 and then returning to step 106). In this manner, a user may adjust each location indicator sequentially until all of the location indicators have been correctly positioned relative to corresponding locating features on display screen 14.

After completing the repositioning of the last location indicator (where n=N), a final confirmation message may be presented to the user confirming that the final positions of all N of the location indicators are correct. If a user inputs a response indicating that the positions are not correct, then in the illustrated method may re-initialize all N location indicators by moving them to their initial positions. Alternatively, in other embodiments, a user may be requested to select which indicators are incorrectly placed, and then to adjust the placement of just those indicators, rather than starting the process anew. In still other embodiments, the final confirmation step may be omitted, and the confirmation at 112 that the Nth indicator is correctly placed may serve as a final confirmation.

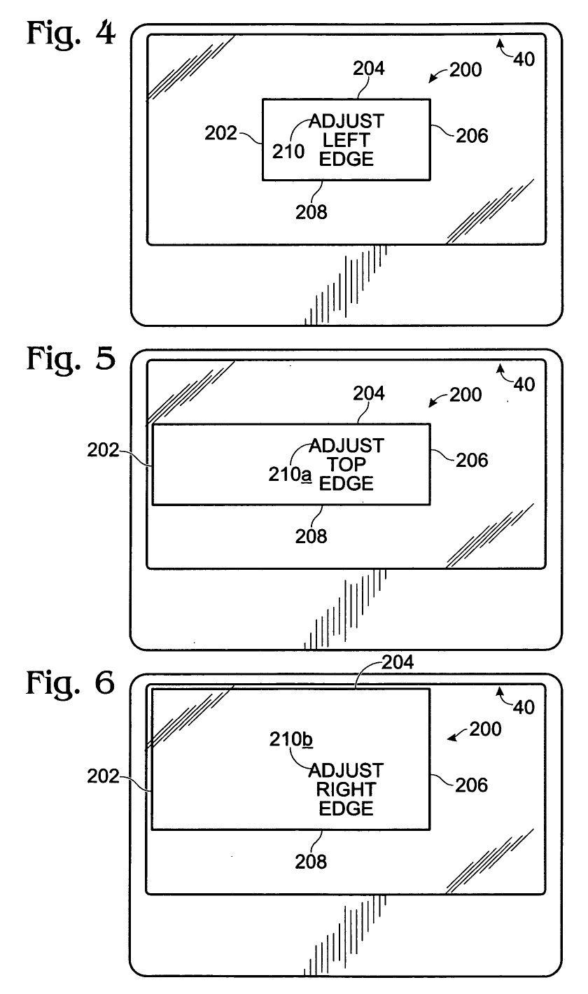

FIGS. 4-8 illustrate an exemplary embodiment of a location indicator, and the changes in the appearance and locations of the indicator during a calibration process. First referring to FIG. 4, the location indicator 200 appears as a rectangular shape located in a central location on display screen 14. Location indicator 200 includes left border indicator 202, top border indicator 204, right border indicator 206 and bottom border indicator 208. Each of the border indicators 202-208 is initially spaced from a corresponding side of the viewing area of display screen 14 (as defined by an inner perimeter of bezel 40). Furthermore, a message 210 may be displayed indicating to a user which indicator to adjust first. In the depicted embodiment, message 210 is located in a central location on display screen 14, but it will be appreciated that message 210 may be displayed at any other suitable location on display screen 14, or may even be omitted (for example, where an instructional manual provides instructions on how to adjust the border indicators).

While border indicators 202-208 each take the form of a generally straight line oriented generally parallel to a corresponding side of the viewing field of display screen 14, it will be appreciated that the border indicators may take any other suitable form. For example, indicator 200 may take the form of a solid rectangle (as opposed to the open rectangle of the depicted embodiment), and each border indicator 202-208 may take the form of an outer border of the solid rectangle. Alternatively, each indicator 202-208 may take the form of a spot, dot or other small mark, or indicator 200 may take the form of a “+” shape located in an approximately centered location on display screen 14, wherein each of the four ends of the “+” shape is a border indicator for a corresponding side of the field of view of display screen 14.

As prompted by message 210, a user may adjust left border indicator 202 by inputting a request to move the left border indicator 202 toward a left inner edge of bezel 40. As described above, the movement of the indicator may be shown in real-time on display 14 as the user inputs the movement request. When the left border indicator 202 is positioned alongside of the left inner edge of bezel 40, the user may confirm that left border indicator 202 has been correctly positioned, for example, by pressing a “select” or “enter” control on a keypad, keyboard, remote control device, or other input device. FIG. 5 shows display screen 14 after left border indicator 202 has been positioned against the left inner edge of bezel 40. After the user confirms that left border indicator 202 has been correctly positioned, a new message 210a is displayed requesting the user to position the next border indicator.

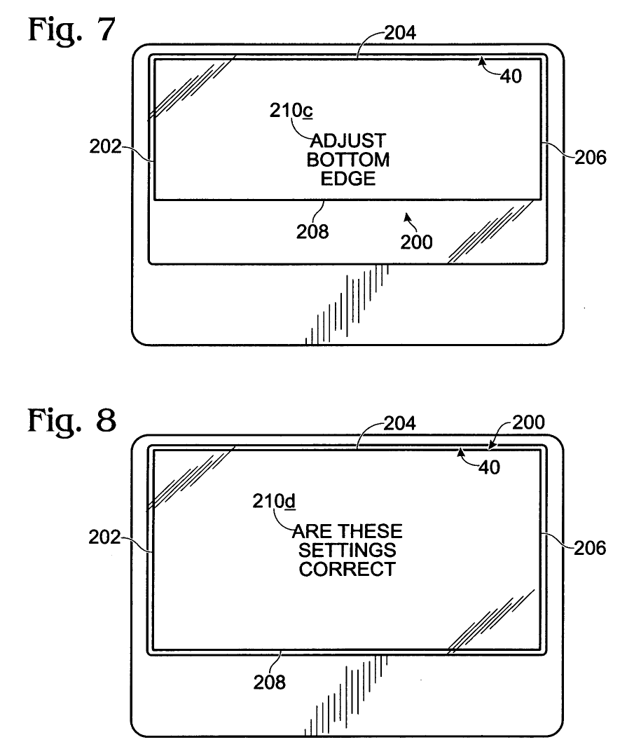

As prompted by message 210a, a user may adjust top border indicator 204 by inputting a request to move the top border indicator 204 toward a top inner edge of bezel 40. When top border indicator 204 is positioned alongside of the top inner edge of bezel 40, the user may confirm that top border indicator 204 has been correctly positioned, for example, by pressing a “select” or “enter” control on input device 35, remote control device 36, or other input device. FIG. 6 shows display screen 14 after top border indicator 204 has been positioned against the top inner edge of bezel 40. Like operations may then be performed for right border indicator 206 (prompted by message 210b, as indicated in FIG. 7, and for bottom border indicator 208 (prompted by message 210c), as indicated in FIG. 8.

Once all border indicators 208 are positioned, the user may be presented with a message requesting confirmation that the border indicators are correctly positioned, as shown at 210d. Alternatively, message 210d may be omitted, and confirmation of the last border indicator that is positioned may serve as the final confirmation of the calibration process. After all of the border indicators 202-208 are correctly positioned, controller 30 may set the optics and/or electronics of display system 10 to display images in the area defined by the moved positions of border indicators 204-208. In this manner, both the correct size and location of an image to be displayed on display screen 14 may be quickly and easily set in an intuitive manner, thereby avoiding a potentially labor-intensive iterative process. Additionally, the calibration routine may be easily performed by an end user if recalibration of the image position and/or size is ever needed. While the border indicators are set in a left-top-right-bottom order in the depicted embodiment, it will be appreciated that the indicators may be set in any suitable order.

Although the present disclosure includes specific embodiments, specific embodiments are not to be considered in a limiting sense, because numerous variations are possible. The foregoing embodiments are illustrative, and no single feature, component, or action is essential to all possible combinations that may be claimed in this or later applications. The subject matter of the present disclosure includes all novel and nonobvious combinations and subcombinations of the various elements, features, functions, and/or properties disclosed herein. The following claims particularly point out certain combinations and subcombinations regarded as novel and nonobvious. These claims may refer to “a” or “a first” element or the equivalent thereof. Such claims should be understood to include incorporation of one or more such elements, neither requiring nor excluding two or more such elements. Further, ordinal numbers, such as first, second, and third, for identified elements or actions are used to distinguish between the elements and actions, and do not indicate a required or limited number of such elements or actions, nor a particular position or order of such elements or actions unless otherwise specifically stated. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. In an image display device including a display screen, a method of calibrating a position of an image in a viewing area of the display screen, the method comprising:
displaying a location indicator in an initial location on the display screen;
receiving an input requesting a repositioning of the location indicator to a changed location on the display screen and, in response, changing the location of the location indicator to the changed location on the display screen; and
adjusting at least one of the size and the position of the image displayed on the screen from at least one of an initial size and an initial position based upon the changed location of the location indicator.

2. The method of claim 1, wherein the location indicator is a border indicator.

3. The method of claim 2, wherein the border indicator includes a line displayed on the screen, and wherein the line is oriented generally parallel to a side of a border of the viewing area.

4. The method of claim 3, wherein the initial location is spaced from the side of the border of the viewing area, and wherein the changed location is substantially at the border of the viewing area.

5. The method of claim 1, wherein the location indicator is a first location indicator and is configured to be positioned substantially at a first side of the viewing area when in the changed position to calibrate a location of a first side of the image, further comprising a second location indicator configured to be positioned along a second side of the viewing area to calibrate a location of a second side of the image.

6. The method of claim 5, further comprising a third location indicator and a fourth location indicator configured to calibrate a third side and a fourth side of the image, respectively.

7. The method of claim 6, wherein the first, second, third and fourth location indicators are each a single side of a rectangular-shaped indicator, and wherein changing the location of the indicator on the display screen includes moving at least one side of the rectangular-shaped indicator toward at least one of the first, second, third and fourth sides of the viewing area to increase an area inside of the rectangular-shaped indicator.

8. The method of claim 7, wherein each side of the rectangular-shaped indicator is moved to a corresponding side of the viewing area to thereby define a size and location of the image in the viewing area.

9. The method of claim 1, wherein the input requesting a repositioning of the indicator is received from one of a remote control device, a keypad and a user-operable input device.

10. The method of claim 1, further comprising receiving a confirmation input confirming the changed position before adjusting at least one of the size and the position of the image displayed on the display screen.

11. In an image display device including a display screen, a method of setting a size and position of an image displayed on the display screen, the method comprising:
displaying a plurality of border-locating indicators on the display screen, wherein each border-locating indicator is displayed in a corresponding initial position;
receiving an input requesting a repositioning of a selected border-locating indicator to a changed location on the display screen, wherein the changed location represents a border of a viewing area of the display screen;
changing the location of the selected border-locating indicator to the changed location on the display screen; and
adjusting at least one of the size and the location of an image displayed on the display screen based upon the changed location of the selected border-locating indicator.

12. The method of claim 2, wherein the display screen has a generally rectangular viewing surface having a left border, a right border, a top border, and a bottom border, and wherein the plurality of border-locating indicators includes a left border-locating indicator, a right border-locating indicator, a top border-locating indicator, and a bottom border-locating indicator.

13. The method of claim 12, wherein the left border-locating indicator, the right border-locating indicator, the top border-locating indicator and the bottom border-locating indicator comprise a left side, a right side, a top side and a bottom side, respectively, of a generally rectangular indicator.

14. The method of claim 13, wherein the changing the location of the selected border-locating indicator on the display screen includes moving a side of the generally rectangular indicator toward a corresponding border of the field of view of the display screen.

15. The method of claim 14, further comprising moving each of the left side, right side, top side and bottom side of the generally rectangular indicator toward corresponding borders of the display screen to outline a viewing area of the display screen.

16. The method of claim 11, wherein receiving an input requesting a repositioning of a selected border-locating indicator includes receiving a plurality of inputs requesting repositionings of the plurality of border-locating indicators.

17. The method of claim 11, further comprising receiving a confirmation input confirming the changed position before adjusting at least one of the size and the position of the image displayed on the display screen.

18. In an image display device including a display screen, a method of calibrating at least one of a size and a position of an image in a viewing area of the display screen, the method comprising:
displaying a left border-locating indicator, a right border-locating indicator, a top border-locating indicator, and a bottom border-locating indicator in corresponding initial locations on the display screen;
receiving an input representing a repositioning of the left border-locating indicator to a first changed location on the display screen and, in response, changing the location of the left border-locating indicator to the first changed location on the display screen, wherein the first changed location represents a left border of a field of view of the display screen;
receiving an input representing a repositioning of the right border-locating indicator to a second changed location on the display screen and, in response, changing the location of the right border-locating indicator to the second changed location, wherein the second changed location represents a right border of the field of view of the display screen;
receiving an input representing a repositioning of the top border-locating indicator to a third changed location on the display screen and, in response, changing the location of the top border-locating indicator to the third changed location, wherein the third changed location represents a top border of the field of view of the display screen;
receiving an input representing a repositioning of the bottom border-locating indicator to a fourth changed location on the display screen and, in response, changing the location of the bottom border-locating indicator to the fourth changed location, wherein the fourth changed location represents a bottom border of the field of view of the display screen; and
adjusting at least one of the size of the image and the position of the image on the display screen from an initial size and an initial position based upon the first, second, third and fourth changed locations.

19. An image display device, comprising:
an image source;
a display screen;
and a controller configured to control the display of an image on the screen by the image source, wherein the controller is configured to calibrate a position of an image in a viewing area of the display screen by displaying a location indicator in an initial location on the display screen, receiving an input requesting a repositioning of the location indicator to a changed location on the display screen and, in response, changing the location of the location indicator to the changed location on the display screen, and adjusting at least one of the size and the position of the image displayed on the screen from at least one of an initial size and an initial position based upon the changed location of the location indicator.

20. The image display device of claim 19, wherein the location indicator is a border-locating indicator.

21. The image display device of claim 20, wherein the border-locating indicator includes a line displayed on the screen, and wherein the line is oriented generally parallel to a side of a border of the viewing area.

22. The image display device of claim 21, wherein the initial location is spaced from the side of the border of the viewing area, and wherein the changed location is substantially along the border of the viewing area.

23. The image display device of claim 19, wherein the location indicator is a first location indicator and is configured to be positioned substantially at a first side of the viewing area when in the changed position to calibrate a location of a first side of the image, further comprising a second location indicator configured to be positioned along a second side of the viewing area to calibrate a location of a second side of the image.

24. The image display device of claim 23, further comprising a third location indicator and a fourth location indicator configured to calibrate a third side and a fourth side of the image, respectively.

25. The image display device of claim 24, wherein the first, second, third and fourth location indicators are each a single side of a rectangular-shaped indicator, and wherein changing the location of the location indicator on the display screen includes moving at least one side of the rectangular-shaped indicator toward at least one of the first, second, third and fourth sides of the viewing area to increase an area inside of the rectangular-shaped indicator.

26. The image display device of claim 25, wherein each side of the rectangular-shaped indicator is moved to a corresponding side of the viewing area to thereby define a size and location of the viewing area.

27. The image display device of claim 19, wherein the input requesting a repositioning of the location indicator is received from a remote control device.

28. The image display device of claim 19, further comprising receiving a confirmation input confirming the changed position before adjusting at least one of the size and the position of the image displayed on the display screen.
